(19) United States
(12) Patent Application Publication
(10) Pub. No.: US 2009/0000664 A1
(43) Pub. Date: Jan. 1, 2009

(54) Batch interface reducing agent (BIRDA)

(76) Inventors: Glenn F. Perry, Pender Island (CA); Greg Molaro, Calgary (CA)

Correspondence Address: MACPHERSON KWOK CHEN & HEID LLP, 2033 GATEWAY PLACE, SUITE 400, SAN JOSE, CA, 95110, US

(21) Appl. No.: 12/005,864

(22) Filed: Dec. 27, 2007

Related U.S. Application Data
(60) Provisional application No. 60/946,335, filed on Jun. 26, 2007.

(51) Int. Cl. F17D 3/03; F15D 1/06

(52) U.S. Cl. 137/2; 137/13

(57) ABSTRACT

A method of reducing the batch interface mixing on heavy crude oil and bitumen pipelines through injection of a batch interface reducing agent (BIRDA) into the batch, and recovery of the material from the batch. The BIRDA is comprised of low carbon count hydrocarbons in the ethane to pentane range, or a mixture thereof.

### CROSS REFERENCE TO RELATED APPLICATIONS

This application claims the benefit of priority of U.S. Provisional Patent Application No. 60/946,335 filed Jun. 26, 2007, which is incorporated herein by reference in its entirety.

### FIELD OF THE INVENTION

The present invention relates generally to a method and apparatus for sequential transport of a first fluid and a second fluid through a conduit. More particularly, the present invention relates to batch transport of fluids through a pipeline.

### BACKGROUND OF THE INVENTION

U.S. Pat. No. 6,582,591 (Jaubert et al.) describes an invention whereby a batch of naphtha can be transported in a crude oil pipeline by sequentially transporting a condensate batch at the head and the tail of the naphtha batch. This patent describes the various known techniques used to reduce interface size such as a) avoiding pump station shutdowns which result in pipeline surges, b) rinsing the pumping stations, c) making the batches as big as possible and d) grouping together batches with similar qualities. The main issue dealt with in U.S. Pat. No. 6,582,591 is the deposits on the pipe wall that will trail back from a crude oil and be scrubbed clean by the naphtha batch, and the use of a condensate buffer to scrub the walls before encountering the naphtha batch.

U.S. Pat. No. 7,100,627 (Hollander) describes an invention whereby a buffer fluid, similar to the two batch fluids, is injected between two batches with different densities to reduce the stratification that can occur in horizontal pipelines. The invention relates primarily to stratification between two dissimilar fluids. This is not applicable to the invention described herein, where the pipeline is in turbulent flow, there is no stratification, the two products do not necessarily have different densities, and the interface is only very indirectly a function of the density of the two products, insofar as it is one of the variables in the definition of the Reynolds Number.

It is generally understood that interface growth between batches in a turbulent pipeline is a function of the degree of turbulence fluids achieve within the pipeline, the greater the turbulence, the less the two batches mix at the point of interface. Laminar or near laminar flow leads to an exceedingly large interface and is usually to be avoided if batch separation is to be achieved. The prime determinant of turbulence is the Reynolds Number. This is a dimensionless number that is defined, in imperial units, as:

Re=124*velocity(ft/sec)*pipe diameter(inches)*density(lb/ft3)/viscosity(cP) (Equation 1.0)

By far, viscosity has the largest effect of the four variables that determine the Reynolds Number, because it is an exponential function with variability in the range of 2 to over 1,000,000 depending on various oils, blends, and operating conditions. The other three factors would see a range of a maximum of about 2 in most applications.

Batch mixing at the interface is a serious issue for heavy oil transport as the pipeline typically operates in a zone where the Reynolds Number for the heavy oil is just sufficient to establish turbulent flow (Re=3000 to 5000). Over the past 50 years, numerous interface predicting formulae have been developed and are available in the public domain. These formulae predict the degree of mixing based primarily on the Reynolds Number. Review of the various publicly available models for interface growth between light oil products yields a normalized estimate of mixing of 1.0 plus/minus 20% between the various models.

There is a small amount of information available from actual field tests. In one real world test utilizing a 200-mile pipeline carrying gasoline vs. diesel, the results showed that the interface was about ½ of the predicted ranges of the 8 models reviewed within the paper by Rachid, deAraujo and Baptista, “Predicting Mixing Volumes in Serial Transport in Pipelines”, Journal of Fluid Engineering, Vol 124, June 2002, p 528. However, the distribution vs. % mixing was a different shape than had been predicted by all 8 models (which had all a similar shape to each other). This discrepancy relates to the shape of the predicted S Curve model of batch mixing over the interface zone, FIG. 2. The real world test showed a similar shape between the 10%-90% interface region as the models, but the 0%-10% and 90%-100% tails were relatively longer. None of the 8 models appears to reflect this relevant piece of information from the field test. The range of model uncertainty becomes more pronounced as batch viscosity increases with heavy oil and the Reynolds Number decreases and the pipeline approaches laminar flow, equal to a normalized estimate for mixing of 1.0 plus/minus 50% between the various models at a Re=5000.

There is a dearth of test data to support any of the formulae. The computer simulation summarized in Table 1 is based on the Austin-Palfrey technique of the paper by Austin, J. E. and Palfrey, J. R. “Mixing of Miscible but Dissimilar Liquids in Serial Flow in a Pipeline”, Proc. Instn. Mech. Engrs., 1963-64; Vol 178, Pt 1, No 15, one of the most conservative models of the various ones available (it predicts the greatest interface). The invention described is independent of the size of the interface as it describes how the interface can be reduced in all circumstances, so this range of uncertainty is not relevant to the principle of the invention. Table 1 illustrates that the interface zone between 99/1% and 1/99% purity levels with two heavy oils can grow to 140,000 Bbl in a 30″ line over 2250 miles. The area under the S curve in FIG. 2 shows that about 15% of the second product finds its way into the first product. If the batch is 200,000 Bbl, the first product is (15%*140=21/200=)10.5% mixed with the second product. This is the mathematical analysis technique behind Table 1.

The typical method to deal with interface growth in heavy oil batches is to run several similar batches in a batch train. This does not directly address the mixing issue. Implicitly, this method accepts whatever level of mixing is yielded by the situation, and essentially increases the dilution effect by increasing the batch size. Because each batch requires sufficient storage at either end of the pipeline to load and unload the system, larger batches involve additional cost.

A more interventionist approach is to insert a light oil batch or buffer between the two heavy oil batches, because the light oil travels down the pipeline in a high state of turbulence with Reynolds Number>25,000, it reduces the trail back from the heavy oil which is in near-laminar flow. Table 1 shows that this reduces the interface size to ¼ of the base case or to about 46,000 Bbl (with 15% or 7,000 Bbls of mixed batches) but it involves the inevitable downgrade of the light oil as it is turned into heavy oil. This downgrade is a major drawback of the technique whenever the light oil value cannot be recovered (which is usually the case to some degree). With a current differential of $25/Bbl between light and heavy oil, the downgrade cost can be high. However, the more usual situation is that each product batch changes by only a few percent mixing and the effect is masked or diluted. The light oil suffers, the heavy oil benefits, but it's a smaller wastage factor. A more reasonable loss estimate of $2 per barrel of light oil would still represent a cost per batch of $14,000, so this cost is still significant.

A more difficult situation arises if there is no light oil available to use as a buffer, primarily caused by economic circumstances beyond any party's control. In these circumstances, mechanical separation pigs can be inserted between the adjacent batches. The drawbacks of this method are: the handling, wear, maintenance and operating expense of dealing with the mechanical pigs and the required capital facilities required to by-pass each pump station. In addition, this technique produces a large volume of interface mix caused by: pig handling techniques at each pump station and the leak-by around the pig at the pipe wall. This technique results in significant mixing. This mixing often equals or exceeds the mixing results from the use of light oil buffers, and, because of the incremental operating issues, is excluded from being used in normal practice.

### SUMMARY OF THE INVENTION

This invention describes a method to control or reduce interface mixing. It involves the selective injection of a BIRDA directly or indirectly into one or both batches. BIRDA are defined as hydrocarbons with a carbon count of two to five including ethane, ethylene, propane, propylene, i-butane, n-butane, butene, butylene, butadiene and the entire class of C5 hydrocarbons including n-pentane and i-pentane, and includes mixtures thereof. The injection occurs at the point of contact between the two adjacent batches and for some “distance” back into each batch. In referring to “distance” it is understood that the injection occurs at an injection point (or points) and that the batch is flowing through the pipeline, so practically speaking, the BIRDA is injected on a “time” or “volume” basis.

The BIRDA increases the Reynolds Number of the fluid at the point of contact, which increases the turbulence of the flow at that point, this area of turbulence reduces the growth of said interface away from point where the batches contact. It can easily be demonstrated that injecting a BIRDA in the middle of the batch has no effect on the mixing, see FIG. 2 the “S” curve. There is no mixing in the middle of the batch to begin with (the part of FIG. 2 to the left of the graph); therefore it cannot be reduced below zero.

A basic feature of the invention is to place different concentrations of BIRDA along the batch, with the peak BIRDA concentration occurring at or near the point of contact between batches. Aside from this basic feature, there will be numerous different arrangements of the fluid injection to optimize different situations. This could include such arrangements as a secondary injection downstream on the pipeline right at the contact point to “top up” the BIRDA. There will be a maximum injection limit based on preventing asphaltene precipitation within the fluid, estimated to be around 40-60% of the BIRDA by volume, but this injection limit is highly dependent on the oil and the BIRDA.

In most pipelines, the entire class of BIRDA would be unacceptable in the crude oil streams because of vapor pressure or bubble point pressure. The BIRDA must be recovered at the delivery end of the pipeline, and this recovery step forms an important part of the invention. The BIRDA can then be re-cycled although this is not a necessary part of the invention. The growth and spread of the interface along the route takes away any sharp transition in BIRDA concentration, the process of traveling down the pipeline smoothes the BIRDA distribution and makes for an easier recovery operation at a lower peak concentration. It is observed that this method can only be retrofitted onto an existing pipeline if the line is rated to carry HVP NGL. This limits the application of BIRDA with HVP hydrocarbons to HVP NGL pipelines (or gas pipelines with the correct pressure rating). Because all existing NGL pipelines are small, typically in the 6″-12″ range, they are economically unsuitable for heavy oil transport which typically requires large pipelines to reach economy of scale. Furthermore, there are very few large NGL pipelines that the author is aware of. This invention will likely require a new pipeline system for implementation.

The ethane (C2) through pentane (C5) hydrocarbons provide several advantages:
1. BIRDA are easy to recover. For example, the lighter hydrocarbons will easily boil and can be distilled at near room temperature and pressure conditions. This is shown in Table 3.
2. There is virtually no product cross mixing during separation between either the BIRDA and/or the heavy oil that cannot be undone through this mild boiling or distillation operation described in 1. BIRDA that is added to the oil at the beginning can be readily removed at the end.
3. BIRDA are usually available in large quantities at the same source as the heavy oil and are usually consumed in large quantities at the same destination.
4. BIRDA can become paying cargo to the pipeline in the circumstances described in 3 above.

It is an object of the present invention to obviate or mitigate at least one disadvantage of previous methods for transporting a first and a second fluid in sequence.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

Table 1 illustrates the batch mixing resulting from two contiguous heavy oil batches on a long distance 30″ pipeline operating just into the turbulent zone;

FIG. 2 illustrates a typical mixing curve, called the “S” curve, using the A-P technique; and

Table 3 is the standard boiling point of the ethane (C2) to octane (C8) hydrocarbons at atmospheric pressure and illustrates how recovery of the hydrocarbons from ethane (C2) to pentane (C5) can be accomplished at conditions near to room temperature and pressure.

### DETAILED DESCRIPTION

Generally, the present invention provides a method and system of reducing the batch interface mixing on heavy crude oil and bitumen pipelines through injection of a batch interface reducing agent (BIRDA) into the batch, and recovery of the material from the batch. The BIRDA is comprised of low carbon count hydrocarbons in the ethane to pentane range, or a mixture thereof.

Table 1 illustrates the batch mixing resulting from two contiguous heavy oil batches on a long distance 30″ pipeline operating just into the turbulent zone. The base case interface is in the order of 140,000 Bbl at 250 KBPD. The interface reduces as the volume increases because of the sensitivity of the Re to velocity shown in equation 1.0. The interface can be reduced through other techniques based on increasing the Re, such as using a light oil buffer or injection of NGL. The use of the invention can be seen to reduce the interface mixing to about ½ of the base case, while the use of light oil buffers reduces the interface to ¼ of the base case. These cases are based on changing the composition of only one of the batches; the dilbit batch stays the same. If both batches are changed by the injection of BIRDA, the interface reduction would be greater;

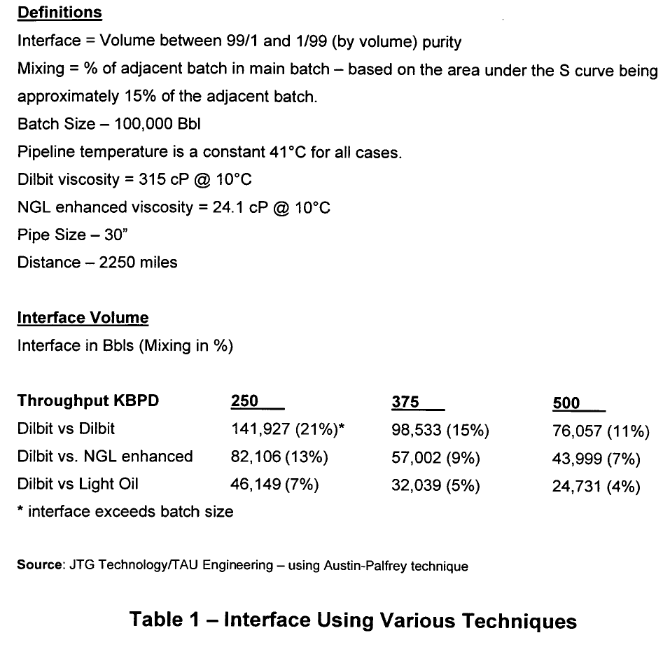

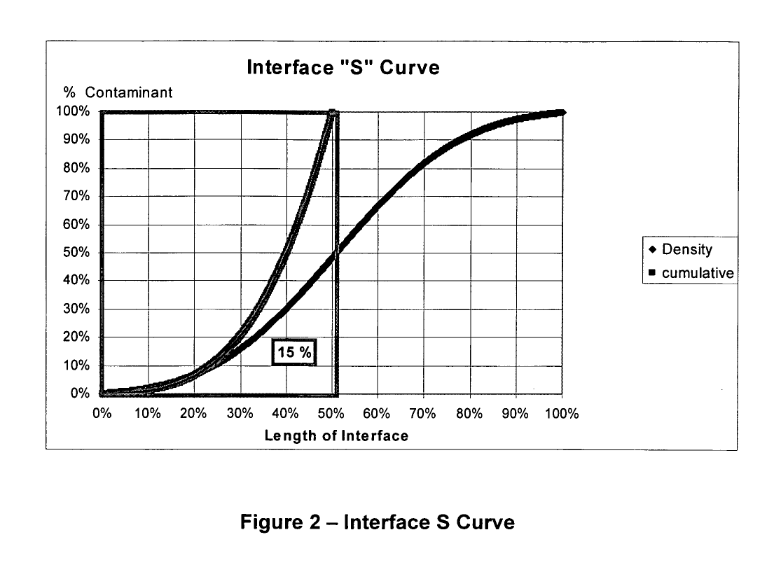

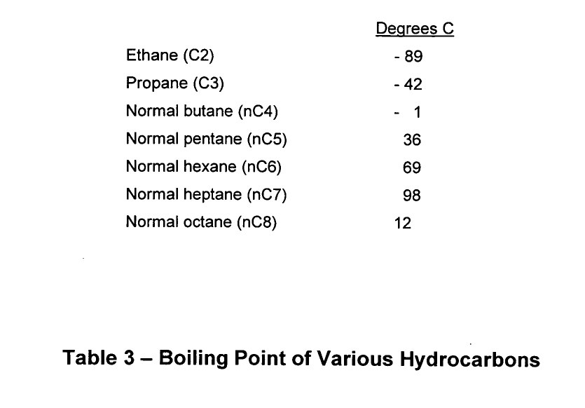

FIG. 2 illustrates a typical mixing curve, called the “S” curve, using the A-P technique. It shows that at a 50% of the batch mid-point, the relative concentration of each batch is 50%. This tails off as one moves away from the mid-point, such that the mixing is about 10% at the 25% location along the interface. The cumulative total (integral) under the curve is also shown as a % of the total cumulative mixing. This shows that the mixing at the 25% location is only 10% of the total mixing at the 50% location. In other words, 90% of the mixing occurs between the 25% and the 50% location, 10% of the mixing occurs between the 0% and the 25% location;

Table 3 is the standard boiling point of the ethane (C2) to octane (C8) hydrocarbons at atmospheric pressure and illustrates how recovery of the hydrocarbons from ethane (C2) to pentane (C5) can be accomplished at conditions near to room temperature and pressure, thus having minimal cost. It also illustrates how hydrocarbon diluents heavier than pentane can be left in the oil and the oil will still meet the vapour pressure specifications on most existing pipelines and systems.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A method for controlling or reducing interface mixing between a first fluid batch and a second fluid batch transported in sequence in a pipeline, comprising selectively injecting a BIRDA into the first fluid batch or the second fluid batch or both, wherein the injection of BIRDA commences prior to the point of contact between the adjacent first fluid batch and the second fluid batch and for some distance back into each batch.

2. The method of claim 1, wherein the BIRDA are hydrocarbons with a carbon count of two to five including ethane, ethylene, propane, propylene, i-butane, n-butane, butene, butylene, butadiene and the entire class of C5 hydrocarbons including n-pentane and i-pentane, and includes mixtures thereof.

3. A method for the transport of a first fluid batch, and a second fluid batch, in sequence through a pipeline comprising:
a. conveying the first fluid batch through the pipeline;
b. conveying the second fluid batch through the pipeline, wherein an interface is defined between the first fluid batch and the second fluid batch; and
c. injecting a BIRDA at and near the interface point.

4. The method of claim 3, further comprising selecting a BIRDA injection start point and a BIRDA injection end point, wherein the BIRDA injection start point is in the first fluid batch.

5. The method of claim 3, further comprising selecting a BIRDA injection start point and a BIRDA injection end point, wherein the BIRDA injection end point is in the second fluid batch.

6. The method of claim 3, further comprising selecting a BIRDA injection start point and a BIRDA injection end point, wherein the BIRDA injection start point is at substantially the interface point.

7. The method of claim 3, further comprising selecting a BIRDA injection start point and a BIRDA injection end point, wherein the BIRDA injection end point is at substantially the interface point.
